(19) United States
(12) Patent Application Publication
(10) Pub. No.: US 2012/0190307 A1
(43) Pub. Date: Jul. 26, 2012

(54) METHOD FOR ADJUSTING IDLE-TIMEOUT PERIOD ACCORDING TO TIME-INTERVAL VARIATION RATE DERIVED FROM TIME INTERVALS OF DATA TRANSMISSION AND RELATED WIRELESS COMMUNICATION DEVICE THEREOF

(76) Inventor: Jia-Bin Huang, Hsin-Chu City (TW)

(21) Appl. No.: 13/291,109

(22) Filed: Nov. 8, 2011

(30) Foreign Application Priority Data
Jan. 24, 2011 (TW) 100102462

(51) Int. Cl. H04W 24/02

(52) U.S. Cl. 455/67.11

(57) ABSTRACT

A method for adjusting an idle-timeout period of a connection between a wireless communication device and a host includes following steps: detecting a plurality of time intervals of data transmission between the wireless communication device and the host; generating a time-interval variation rate according to the time intervals; and adjusting the idle-timeout period according to the time-interval variation rate.

### BACKGROUND OF THE INVENTION

1. Field of the Invention

The disclosed embodiments of the present invention relate to adjusting an idle-timeout period, and more particularly, to a method for adjusting an idle-timeout period of a connection between a wireless communication device and a host and related wireless communication device thereof.

2. Description of the Prior Art

Wireless human interface devices, such as a keyboard or a mouse, can establish a connection with a host (e.g. a computer system) through wireless frequency spectrum, such as industrial, scientific and medical (ISM) spectrum, thereby allowing a user to operate the wireless human interface device to control the host to proceed with related operations. Due to the inherent characteristics of wireless communications, the wireless human interface device can not draw electricity from the host, and has to rely on an independent power supply, such as a battery or other energy storage devices, to supply the required electricity for receiving user operational signals (e.g., a button-enable signal generated from a keyboard; or a displacement or button-enable signal generated from a mouse) and transmitting these user operational signals to the host such that the host accordingly executes corresponding operations (e.g., displaying a mouse-related displacement and button-enable effect on a monitor of a computer system). Therefore, in order to reduce power consumption of the wireless human interface device, a typical wireless human interface device usually has a power saving mechanism. For example, after a fixed period of time in which no user operation is performed on the wireless human interface device expires, the wireless human interface device will initiate a disconnection procedure between the wireless human interface device and the host to avoid unnecessary power consumption. For example, after the user stops using the wireless human interface device for a period of time (e.g., a wireless mouse stays still for more than 15 minutes, or a wireless keyboard has no keystroke for more than 20 minutes), the wireless human interface device will actively disconnect from the host to stay in a disconnected status until the wireless human interface device detects that the user operates the wireless human interface device again (e.g., the user moves the wireless mouse, or the user uses the wireless keyboard). Next, the wireless human interface device would actively reestablish a connection with the host again.

However, during the process of establishing the connection between the wireless human interface device and the host, if a protocol handshaking procedure between the wireless human interface device and the host is executed, the process takes a period of time, sometimes several seconds. Thus, it consumes much power. With regard to a Bluetooth wireless device, a Bluetooth human interface device and the host need to execute extra protocol handshaking procedures, such as a link manager protocol (LMP) handshaking procedure and a logical link control and adaptation protocol (L2CAP) handshaking procedure, so as to establish a Bluetooth wireless connection. On the other hand, during a period of time in which the connection between the wireless human interface device and the host is being established, every operation performed by the user on the wireless human interface device is invalid, which results in user's inconvenience and is easily mistaken as a malfunction of the wireless human interface device. In addition, since every user has his/her customary activity (e.g., when a user is used to prolonged use of a computer system and encounters something might need to halt the operation of the wireless keyboard for thinking, if the think time exceeds a wait time of the wireless keyboard, the wireless keyboard will actively disconnect from the host, which causes that when the user wants to use the wireless keyboard again, the user might suffer from setbacks resulting from the wireless keyboard reconnecting the host, and the reconnection procedure might cause power consumption. Similarly, when the user seldom uses the wireless keyboard, the wireless keyboard still needs to wait for a fixed period of time to disconnect from the host, causing extra power consumption. Therefore, regarding the power management, the wireless human interface device employing the conventional method of waiting for a fixed period of time to disconnect from the host is very inefficient, causes extra power waste, and compromises the convenience of the wireless human interface device.

### SUMMARY OF THE INVENTION

In accordance with exemplary embodiments of the present invention, a method for adjusting an idle-timeout period according to a time-interval variation rate of data transmission and related wireless communication device thereof are proposed to solve the above-mentioned problem.

According to a first aspect of the present invention, an exemplary method for adjusting an idle-timeout period of a connection between a wireless communication device and a host is disclosed. The exemplary method includes following steps: detecting a plurality of time intervals of data transmission between the wireless communication device and the host; generating a time-interval variation rate according to the time intervals; and adjusting the idle-timeout period according to the time-interval variation rate.

According to a second aspect of the present invention, an exemplary wireless communication device is disclosed. The exemplary wireless communication device includes a control unit and a wireless communication unit. The control unit is for generating a control data, and the wireless communication unit is for performing data transmission with a host to transmit the control data to the host. The control unit is utilized to adjust an idle-timeout period of a connection between the wireless communication device and the host, detect a plurality of time intervals of data transmission between the wireless communication device and the host, generate a time-interval variation rate according to the time intervals, and adjust the idle-timeout period according to the time-interval variation rate.

According to a second third of the present invention, another exemplary wireless communication device is disclosed. The exemplary wireless communication device includes a wireless communication unit, a reception unit, and a control unit. The wireless communication unit is for performing data transmission with a host. The reception unit is for receiving an idle-timeout period from the host. The idle-timeout period is generated according to a time-interval variation rate generated by detecting a plurality of time intervals of data transmission between the host and the wireless communication device. The control unit is for terminating a connection between the host and the wireless communication device according to the idle-timeout period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method according to an embodiment of the present invention.

FIG. 2 is a schematic diagram illustrating a wireless communication device according to an embodiment of the present invention.

FIG. 3 is a schematic diagram illustrating another wireless communication device according to an embodiment of the present invention.

### DETAILED DESCRIPTION

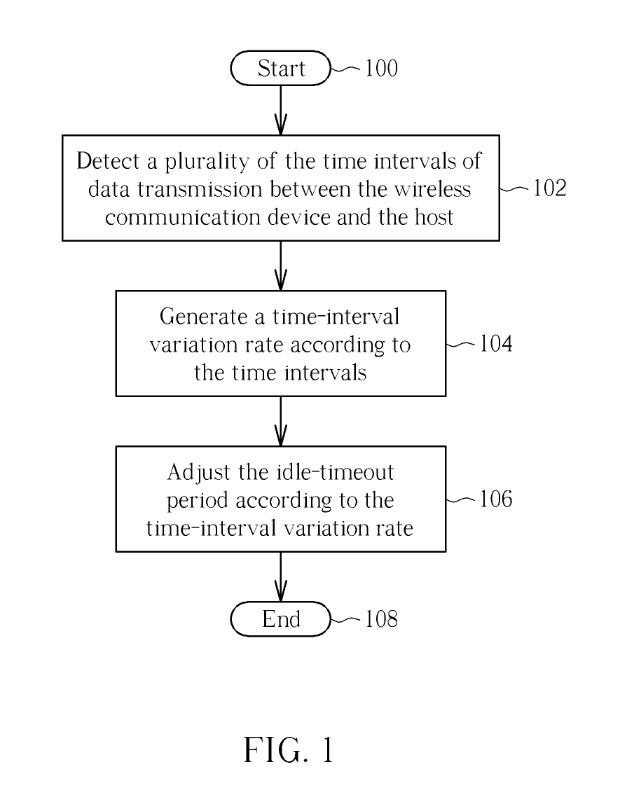

Please refer to FIG. 1, which is a flowchart illustrating a method according to an embodiment of the present invention. The method is applied to data transmission between a wireless communication device and a host for adjusting an idle-timeout period between the wireless communication device and the host, and includes following steps.

Step 100: Start.

Step 102: Detect a plurality of the time intervals of data transmission between the wireless communication device and the host.

Step 104: Generate a time-interval variation rate according to the time intervals.

Step 106: Adjust the idle-timeout period according to the time-interval variation rate.

Step 108: End.

According to the flow, when data transmission is performed between the wireless communication device and the host, the present invention detects the time intervals of data transmission between the wireless communication device and the host, and accordingly generates a time interval variation rate. Next, the present invention adjusts the idle-timeout period of the wireless communication device and the host according to the time-interval variation rate. The idle-timeout period indicates a time period allowing no data transmission between the wireless communication device and the host, and the time intervals indicates a time period between consecutive data transmission between the wireless communication device and the host. In other words, after a connection between the wireless communication device and the host has been established, if there is no data transmission between the wireless communication device and the host over the idle-timeout period, the wireless communication device disconnects from the host. Moreover, if the time interval variation rate indicates that the time intervals are decreasing (i.e., the time intervals of data transmission between the wireless communication device and the host decrease become shorter gradually), the idle-timeout period of the wireless communication device and the host is increased; and if the time interval variation rate indicates that the time intervals are increasing (i.e., the time intervals of data transmission between the wireless communication device and the host become longer gradually), the idle-timeout period of the wireless communication device and the host is decreased.

Via the flow shown in FIG. 1, the wireless communication device or the host can dynamically adjust the idle-timeout period of the wireless communication device and the host according to the time interval variation rate derived from continuously detecting time intervals of data transmission between the wireless communication device and the host. Since the time intervals of data transmission between the wireless communication device and the host correspond to the frequency of user's use of the wireless communication device, when the user frequently uses the wireless communication device, the time interval variation rate indicates that the time intervals are decreasing, and thus the idle-timeout period of the wireless communication device and the host is increased to prolong a connection time of the connection established between the wireless communication device and the host and accordingly facilitates user's use of the wireless communication device. On the contrary, if user seldom uses the wireless communication device, the time interval variation rate indicates that the time intervals are increasing, and thus the idle-timeout period of the wireless communication device and the host is decreased to shorten the connection time of the connection established between the wireless communication device and the host and accordingly reduce power consumption of the wireless communication device.

Please note that the flow shown in FIG. 1 merely illustrates an embodiment of the present invention. Those skilled in the art can make modifications according to the above-mentioned description, and the present invention is not meant to be limited thereby. For example, the time interval variation rate can be adjusted according to information of user's customary activity during work days. By way of example, during the work days, the time interval variation rate can be adjusted by analyzing the periods in which the user frequently use the wireless communication device, break periods, the most likely off-work time periods, etc. During a period in which the user frequently uses the wireless communication device, the time interval variation rate indicates that the time intervals are decreasing, and the idle-timeout period of the wireless communication device and the host is therefore increased. At this moment, because the connection time of the connection established between the wireless communication device and the host is prolonged, the user is less likely to encounter a response delay introduced due to a reconnection procedure that is initiated after the wireless communication device is disconnected from the host. Alternatively, during a period in which the user frequently uses the wireless communication device, the wireless communication device can control a reconnection time of the wireless communication device and the host according to the time interval variation rate after the wireless communication device is disconnected from the host. In this way, the wireless communication device automatically initiates a reconnection procedure for establishing a connection with the host during the rush hours, thereby mitigating the response delay perceived by the user. Similarly, during user's break period, since the time interval variation rate indicates that the time intervals are increasing, the idle-timeout period of the wireless communication device and the host is decreased accordingly. In this way, the power consumption of the wireless communication device is reduced. Of course, determining the time interval variation rate by the frequency of user's use of the wireless communication device during work days is for illustrative purposes only, and is not meant to be a limitation of the present invention. For example, the time interval variation rate determined according to other detection results obtained during a whole day and/or non-work days may be employed to adjust the idle-timeout period of the wireless communication device and the host. In addition, regarding the method for adjusting the idle-timeout period according to the time interval variation rate, those ordinary skilled in the art can make variations and modifications accordingly and the present invention is not meant to be limited thereby. For example, the time interval variation rate can be compared with a threshold to determine whether the idle-timeout period should be increased or decreased. Moreover, the increment or decrement of the idle-timeout period may be determined by using different thresholds.

Besides, in a case where the host actively detects the time intervals of data transmission between the wireless communication device and the host, the host generates information of the idle-timeout period according to the time interval variation rate that is continuously detected, and then transmits the information of the idle-timeout period to the wireless communication device. In this way, when the idle-timeout period is increased, the wireless communication device prolongs the connection time of the connection established between the wireless communication device and the host. When the idle-timeout period is decreased, the wireless communication device shortens the connection time of the connection established between the wireless communication device and the host. Finally, the wireless communication device cuts the connection between the wireless communication device and the host according to the information of the idle-timeout period. In other words, since the host usually contains a mechanism for maintaining the time information, it is convenient for the host to continuously detect the time intervals of data transmission with the wireless communication device to provide a proper idle-timeout period to the wireless communication device. Therefore, the wireless communication device just needs to passively receive the idle-timeout period from the host for proceeding with the following disconnection process with the host.

Therefore, in accordance with the flow of the present invention, when the time intervals of data transmission between the wireless communication device and the host have been continuously detected, the present invention dynamically adjusts the idle-timeout period of the wireless communication device and the host according to the time interval variation rate derived from the time intervals, thereby facilitating the convenience of using the wireless communication device and reducing the power consumption of the wireless communication device.

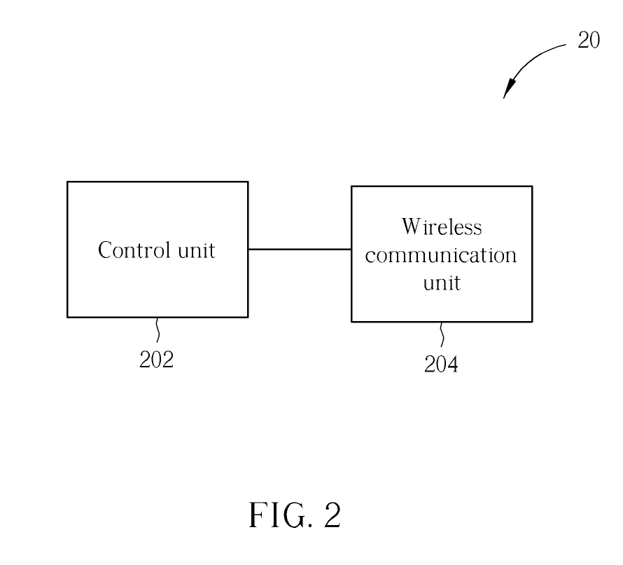

In order to realize the flow shown in FIG. 1, a wireless communication device is therefore proposed. Please refer to FIG. 2, which is a schematic diagram illustrating a wireless communication device 20 according to an embodiment of the present invention. The wireless communication device 20 includes a control unit 202 and a wireless communication unit 204. The control unit 202 is for detecting a plurality of time intervals of data transmission between the wireless communication device 20 and a host, generating a time interval variation rate according to the time intervals, and adjusting the idle-timeout period for disconnection with the host according to the time interval variation rate. When the time interval variation rate indicates that the time intervals are decreasing, the control unit 202 prolongs a connection time of a connection established between the wireless communication device 20 and the host, such that a user is less likely to encounter a response delay introduced due to a reconnection procedure that is initiated after the disconnection of the wireless communication device and the host. When the time interval variation rate indicates that the time intervals are increasing, the control unit 202 shortens the connection time of the connection established between the wireless communication device 20 and the host, such that the power consumption of the wireless communication device 20 is reduced. The time interval variation rate can be used to adjust the idle-timeout period of the wireless communication device and the host according to detection results of data transmission between wireless communication device and the host during a whole day, work days and non-work days. Next, the wireless communication unit 204 is used for transmitting the idle-timeout period determined by the control unit 202 to the host, such that the host and the wireless communication device 20 can proceed with following disconnection process. Besides, during the idle-timeout period of the wireless communication device 20 and the host, the control unit 202 can control a reconnection time of the wireless communication device and the host according to the time interval variation rate, to actively proceed with a reconnection procedure after disconnecting from the host. When the user wants to use the wireless communication device 20 again after the wireless communication device 20 is disconnected from the host, this can mitigate the response delay caused by the reconnection procedure.

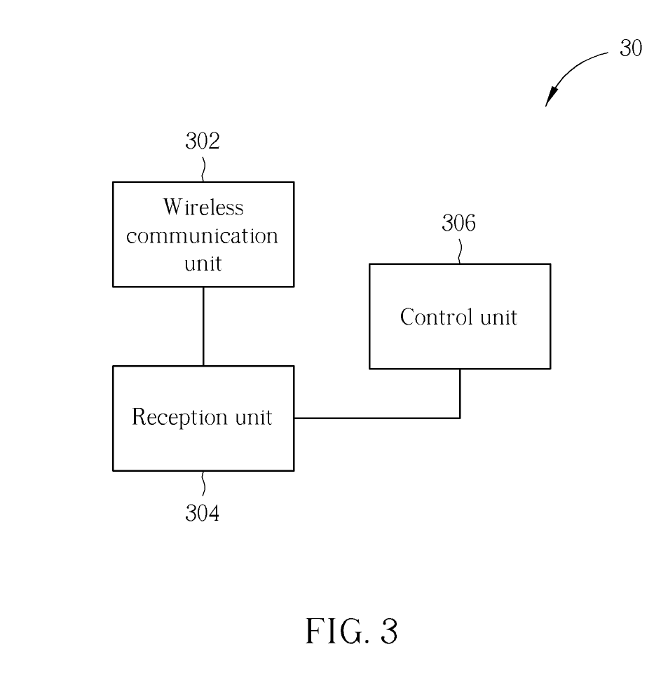

It should be noted that, the concept of the present invention is to detect a plurality of time intervals of data transmission between the wireless communication device and the host, generate a time interval variation rate according to the detected time intervals, and adjust an idle-timeout period of the wireless communication device and the host. Based on such concept, those skilled in the art can make appropriate modifications according to different requirements. For example, please refer to FIG. 3, which is a schematic diagram illustrating another wireless communication device 30 according to an embodiment of the present invention. The wireless communication device 30 includes a wireless communication unit 302, a reception unit 304 and a control unit 306. The difference between the wireless communication device 30 shown in FIG. 3 and the wireless communication device 20 shown FIG. 2 is that the wireless communication device 30 adjusts the idle-timeout period according to the time interval variation rate generated by the host for proceeding with following disconnection process with the host. In detail, the wireless communication unit 302 is used for data transmission with the host. The reception unit 304 is for receiving the idle-timeout period from the host. After the host actively detects a plurality of time intervals of data transmission between the wireless communication device 30 and the host, the idle-timeout period is determined by a time interval variation rate generated according to the detected time intervals. The time interval variation rate can be utilized to adjust the idle-timeout period of the wireless communication device and the host according to detection results of data transmission between the wireless communication device and the host during a whole day, work days and non-work days. Next, the control unit 306 is used for proceeding with the disconnection process of the wireless communication device 30 and the host according to the idle-timeout period received from the host. Besides, the reception unit 304 further receives a reconnection time command from the host. The reconnection time command is generated according to the corresponding time interval variation rate. After the wireless communication device 30 is disconnected from the host, the control unit 306 controls a reconnection time of the wireless communication device 30 and the host according to the reconnection time command for proceeding with the reconnection procedure with the host. Please note that, in addition to passively receiving the reconnection time command from the host to proceed with the reconnection procedure of the wireless communication device 30 and the host after disconnected, the wireless communication device 30 may further include a detection unit for actively detecting a plurality of time intervals of data transmission between the wireless communication device 30 and the host, and generating the time interval variation rate according to the detected time intervals, so as to control the reconnection time of the wireless communication device 30 and the host for the reconnection procedure initiated after the wireless communication device 30 is disconnected from the host.

To sum up, the present invention detects a plurality of time intervals of data transmission between a wireless communication device and a host to thereby acquire a time interval variation rate indicative variation of the time intervals, and then dynamically adjusts the idle-timeout period of the wireless communication device and the host according to the time interval variation rate, which facilitates the use convenience of the wireless communication device and reduces the power consumption of the wireless communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for adjusting an idle-timeout period of a connection between a wireless communication device and a host, the method comprising following steps:
detecting a plurality of time intervals of data transmission between the wireless communication device and the host;
generating a time-interval variation rate according to the time intervals; and
adjusting the idle-timeout period according to the time-interval variation rate.

2. The method of claim 1, wherein the step of adjusting the idle-timeout period according to the time-interval variation rate comprises:
increasing the idle-timeout period when the time-interval variation rate indicates that the time intervals are decreasing; and
shortening the idle-timeout period when the time-interval variation rate indicates that the time intervals are increasing.

3. The method of claim 1, wherein the step of adjusting the idle-timeout period according to the time-interval variation rate comprises:
increasing the idle-timeout when the time-interval variation rate is higher than a threshold; and
shortening the idle-timeout period when the time-interval variation rate is lower than the threshold.

4. The method of claim 1, further comprising:
during the idle-timeout period of the wireless communication device and the host, controlling a reconnection time of the wireless communication device and the host according to the time-interval variation rate.

5. The method of claim 1, wherein the step of detecting the time intervals of data transmission between the wireless communication device and the host comprises: utilizing the host to detect the time intervals; the step of generating the time-interval variation rate according to the time intervals comprises: utilizing the host to generate the idle-timeout period according to the time-interval variation rate; and the step of adjusting the idle-timeout period according to the time-interval variation rate comprises: increasing the idle-timeout period when the time-interval variation rate indicates that the time intervals are decreasing or shortening the idle-timeout period when the time-interval variation rate indicates that the time intervals are increasing; and the method further comprises: utilizing the wireless communication device to receive the idle-timeout period from the host and terminate the connection between the wireless communication device and the host according to the received idle-timeout period.

6. The method of claim 1, wherein the time-interval variation rate indicates information of user's customary activity during a whole day, work days and non-work days.

7. A wireless communication device, comprising:
a control unit, for generating a control data; and
a wireless communication unit, for performing data transmission with a host to transmit the control data to the host;
wherein the control unit is utilized to adjust an idle-timeout period of a connection between the wireless communication device and the host, detect a plurality of time intervals of data transmission between the wireless communication device and the host, generate a time-interval variation rate according to the time intervals, and adjust the idle-timeout period according to the time-interval variation rate.

8. The wireless communication device of claim 7, wherein during the idle-timeout period of the wireless communication device and the host, the control unit is further utilized to control a reconnection time of the wireless communication device and the host according to the time-interval variation rate.

9. The wireless communication device of claim 7, wherein the time-interval variation rate indicates information of user's customary activity during a whole day, workdays and non-work days.

10. A wireless communication device, comprising:
a wireless communication unit, for performing data transmission with a host;
a reception unit, for receiving an idle-timeout period from the host, wherein the idle-timeout period is generated according to a time-interval variation rate generated by detecting a plurality of time intervals of data transmission between the host and the wireless communication device; and
a control unit, for terminating a connection between the host and the wireless communication device according to the idle-timeout period.

11. The wireless communication device of claim 10, wherein the time-interval variation rate indicates information of user's customary activity during a whole day, workdays and non-work days.

12. The wireless communication device of claim 10, wherein the reception unit further receives a reconnection time command that is generated according to the time-interval variation rate; and during the idle-timeout period of the wireless communication device and the host, the control unit further controls a reconnection time of the wireless communication device and the host according to the reconnection time command.

13. The wireless communication device of claim 10, further comprising:
a detection unit, for generating the time-interval variation rate according to the time intervals after detecting the time intervals of data transmission between the wireless communication device and the host.

14. The wireless communication device of claim 13, wherein during the idle-timeout period of the wireless communication device and the host, the detection unit further controls a reconnection time of the wireless communication device and the host according to the time-interval variation rate.
